(19) United States
(12) Patent Application Publication
(10) Pub. No.: US 2004/0076833 A1
(43) Pub. Date: Apr. 22, 2004

(54) Protective graft coatings for metal

(75) Inventors: Mohan L. Sanduja, Flushing, NY (US); Carl Horowitz, Brooklyn, NY (US); Robert Mishiyev, Brooklyn, NY (US); Paul Thottathil, New Hyde Park, NY (US); Peter Klokkedal Sorensen, Aars (DK); Jorgen Mikael Berth, Randers (DK)

Correspondence Address: STEINBERG & RASKIN, P.C., 1140 AVENUE OF THE AMERICAS, 15th FLOOR, NEW YORK, NY, 10036-5803, US

(73) Assignee: LOGSTOR ROR A/S

(21) Appl. No.: 10/253,111

(22) Filed: Sep. 24, 2002

(51) Int. Cl. B32B 27/00

(52) U.S. Cl. 428/422.8; 428/447; 285/18

(57) ABSTRACT

The invention provides a corrosion resistant graft coated metal substrate and a polymeric graft coating covalently bonded thereto. Water-based graft coating compositions and methods for graft coating metal substrates to provide for long term protection from rust and corrosion are also provided.

### FIELD OF THE INVENTION

This invention relates to water-based compositions for the protection of metals from corrosion, methods for using the same and metals protected by the composition and methods described herein.

### BACKGROUND OF THE INVENTION

Many types of metals are employed to produce articles of manufacture and other useful objects. Many of these metals are well known to degrade, i.e., oxidize, corrode, or rust, when exposed to air, corrosive gases or vapors, moisture, galvanic potential and/or from other such environmental causes. In particular, ferrous metals, such as carbon steel, are especially prone to rust unless protected from air and moisture. It is well known to coat corrosion-prone metals with a film or layer of oil, grease, water resistant paint, polymer film, or other barrier in order to prevent air and/or moisture from contacting the steel.

However, the previously known compositions and methods suffer from a number of drawbacks, including costs associated with materials and processing steps, environmental drawbacks, such as emission of organic vapors and the like, and interference by such protective coatings with subsequent manufacturing steps.

For example, in certain industries, articles that are painted or coated to prevent rust during storage and transport, must then be subjected to cutting, welding, joining and further painting or coating processes. Application of welding or cutting torch temperatures to currently available coatings may release toxic fumes. Further, the protective coating and/or a burned coating residue can interfere with welding or other forms of joining of the heated sections, and interfere with the adhesion of further paints or coatings applied during manufacture for cosmetic or protective purposes.

Thus, there is a long felt need in the art for improved and more economical compositions and methods for protecting metals from corrosion. The basic need is to protect such corrosion-prone metals with an easy to apply, protective coating composition that is environmentally safe and that provides effective long-term corrosion protection for metals throughout the useful life of any metal object or article of manufacture, without release of undesirable materials into the environment.

It has been previously proposed to provide corrosion protection by graft coating metals, e.g., objects or articles of manufacture, with a variety of polymer-type materials. Graft coating is a process wherein a coating material is chemically reacted and covalently bonded with a surface to be treated, providing a coating that is more securely applied than, e.g., an adherent layer of paint. However, these previous efforts had one or more shortcomings, relative to the above-stated problems to be solved.

For example, U.S. Pat. No. 4,106,955 describes compositions and methods for graft coating steel machine parts to provide surface smoothness and enhanced resistance to abrasion, wear, and corrosion. The graft coating compositions include acrylic monomers requiring organic solvents, with fillers selected to enhance surface hardness,

U.S. Pat. No. 4,107,228 describes paint compositions and methods for graft painting steels that includes polymerizable vinyl monomer, an epoxy pre-polymer, a polyurethane binder resin, cross-linking or hardening agents and polymerization and molecular graft initiators requiring organic solvent.

U.S. Pat. No. 4,421,569 describes compositions and methods for graft coating steel, that include methacrylates, vinyl pyrrolidone, epoxy resins based on bisphenol A and epichlorohydrin, phenol based or cresol based poly functional epoxy novolac resins, water reducible epoxy esters, water reducible urethane prepolymers or hydroxyl terminated or carboxyl terminated acrylic prepolymers, as prepolymers. While this patent teaches water based reagents, the composition and methods require a complex mixture of monomers and prepolymers plus grafting reagents. Further, the document indicates that the composition and methods were developed in order to provide relatively short-term corrosion protection of steel during commercial distribution and storage prior to installation.

U.S. Pat. No. 5,043,226 describes compositions and methods for deposition of a conductive and protective coating on a metallic substrate by graft coating. This composition requires a nickel salt and a reducing agent to precipitate conductive metallic nickel dispersed in the graft coating.

Thus, there remains a longstanding need in the art for economical, effective and environmentally acceptable compositions and methods for grafting long duration corrosion protective coatings onto metal articles, including carbon steels.

### SUMMARY OF THE INVENTION

Accordingly, the present invention provides compositions and methods for graft modifying or coating the surfaces of metals, including ferrous metals such as carbon steels. The inventive grafting process employs polyfunctional monomers/prepolymers, such as, for example, vinyl monomers, urethane and epoxy prepolymers which are chemically bonded to the metal surface by the grafting process provided herein. Preferably, water-based urethane monomers are employed.

The substrate is preferably formed into an article of manufacture, either before or after the graft coating is applied to the substrate. The article of manufacture is any article suitable to be manufactured from metals needing corrosion protection. Simply by way of example, the article of manufacture is advantageously an elongated member, solid or hollow, e.g., such as a pipe or tube, a rod or shaft, a curved or planar sheet, a beam, a board, a container for solids or fluids, and/or combinations thereof.

### BRIEF DESCRIPTION OF THE FIGURES

FIG. 1 illustrates a proposed mechanism for the graft coating methods.

### DETAILED DESCRIPTION

Accordingly, the invention provides compositions and methods for covalently grafting a polymer or polymers to a substrate. Such grafting involves the “activation” of a substrate to convert some part of the substrate surface into moieties able to covalently bond to one or more supplied monomer, prepolymer or polymer reagents placed in contact with the substrate surface. Activation requires a graft initiator and/or activator, which typically removes hydrogens linked to surface functional groups, producing active moieties ready to covalently bond to a provided reagent. Such hydrogen moieties are found, e.g., in most organic materials. For grafting coatings onto metals or other non-organic materials, hydroxyl moieties present as part of trace surface oxidation are thought to be provide a site for surface activation of such non-organic substrates.

Polymer coatings according to the invention provide treated substrates with a variety of desirable properties. These include, for instance, resistance to corrosion, abrasion, atmospheric corrosive gases or vapors, e.g., hydrogen sulfide, carbon dioxide, sulfur dioxide, nitrous oxide, at relative humidity of 90% or more, and ambient conditions of temperature and pressure. The polymer coating is produced by applying a composition that includes suitable monomers, prepolymers, a graft-initiator, a polymerization initiator or catalyst, and other more conventional additives for appearance and long term stability. These and other features of the invention are described in further detail, below.

### Substrates and Graft Coated Articles

The term “substrate” as employed herein includes any object or article of manufacture that is graft coated with the compositions according to the invention. Preferred substrates include objects, articles of manufacture, and the like, composed of any metal, and particularly a metal or metals needing corrosion protection, as well as mixtures, composites, and alloys thereof.

While it is preferred that the definition of a substrate include a metallic object or article of manufacture in need of corrosion protection, this is not intended to exclude optional nonmetallic objects or articles of manufacture, or optional metal objects or articles of manufacture that may be inherently corrosion resistant. Such nonmetallic substrates and/or corrosion resistant metals may be graft coated with the inventive composition for purposes not related to corrosion protection, e.g., decoration, and/or may be graft coated with the inventive composition while connected to and/or part of an object or article of manufacture that also includes metals needing corrosion protection.

Graft coated substrates, and related objects according to the invention, can be used in, e.g., general industry, consumer products, the building trades, municipal water supply and waste water systems, ocean platforms, e.g., offshore oil and gas platforms, and ship building.

More preferably, the substrate is formed into sheets, tubes, girders, clamps, brackets, folded sheets, and any other useful form or geometric shape. Most commonly, the substrate is a ferrous metal, such as steel, e.g., one of many art-known grades of carbon steel that are prone to corrosion unless coated or otherwise protected from air and moisture. Other metals that may be protected from corrosion by the inventive composition include, simply by way of example, copper, brass, aluminum, silver, and so forth. For instance, these later metals corrode and fail at an accelerated rate when exposed to certain types of acid, alkali, or strong oxidizers, e.g., in the form of vapors, mists or solutions.

Even more preferably, the substrates are in the form of pipes or tubes. For ease of reference, the use of the term, “pipe” or “piping” in the singular or plural herein, is intended to describe substrates or articles of manufacture that are in the form of tubing or conduit, with a circular, elliptical, polygonal, or any other art-known cross section. While such pipe is typically elongated, this is not a requirement, since the invention is also contemplated as useful for protecting other types of substrates, e.g., such as pipe hardware, connectors, brackets, supports, and any other metal object that it is desirable to graft coat with the inventive composition.

Graft coated pipe according to the invention also includes, for example, straight pipe, bent pipe, a straight pipe joint, an elbow joint, an end-cap, a heat-shrinkable joint, and combinations thereof. The graft coated pipe according to the invention also includes, for example, single wall pipe, pipe with a plurality of walls nested one within the other, pipe with a single insulating layer between two concentric walls, and pipe with a plurality of concentric insulating layers, to name but a few types of pipe that will benefit from the graft coating compositions and methods of the invention.

### Grafting Solution or Composition

The grafting solution is preferably prepared in two parts for convenience and storage stability. These are designated as Part A and Part B. Part A includes, for example, all but one of the active components, and Part B includes a crosslinker or crosslinking agent. The full or final grafting solution is prepared prior to use by mixing Part B with Part A in a fixed ratio. The formulation thus prepared is then stirred for uniformity and is applied onto a substrate to be coated, by any art-known method.

Formulation of Part A

Part A of the grafting solution is prepared in a solvent compatible with the reagents selected for grafting. Preferably, this is a water-based solvent, that forms a solution, suspension and/or dispersion when combined with components of Part A. Solvents are selected depending on the prepolymer and/or monomers employed, and can optionally include, in addition to water, compatible polar solvents such as water soluble alcohols, ethers, esters, and derivatives and mixtures thereof, and other readily available water soluble or dispersed solvents.

Graft initiators (“GI”) are preferably metal ions including, for example, iron, silver, cobalt, copper, cerium, and/or combinations thereof, or any other art-known graft initiator. More preferably, as exemplified herein, ferrous ion is employed. The graft initiators are preferably employed in a concentration ranging from about 0.01 to about 1.0%, and more preferably in a concentration ranging from about 0.001 to about 0.1% by weight, relative to the weight of prepolymer or monomer(s) present.

Catalysts (also art-known as polymerization initiators) are preferably peroxides (“ROOH”), wherein R is H or any organic moiety compatible with the desired grafting reaction. Preferred peroxide catalysts include, for example, hydrogen peroxide and any organic peroxide, such as, e.g., benzoyl peroxide, methyl ethyl ketone peroxide, 1-butyl hydroperoxide and derivatives and combinations thereof. The peroxide catalysts are preferably employed in a concentration ranging from about 0.1 to about 5%, or greater. More preferably, the peroxide catalysts are employed in a concentration ranging from about 0.05 to about 1.0% (by wt relative to the solution weight).

Broadly, prepolymers and/or monomers, e.g., water-based or water-dispersed compositions, are preferably employed in the grafting solution in a concentration ranging from about 0.1 to about 80%, by weight, relative to the solution. More preferably, the prepolymers and/or monomers are employed in a concentration ranging from about 0.1 to about 50%, be weight or more, and in certain embodiments, are optionally employed in a concentration ranging from about 0.1 to about 20%, by weight, relative to the grafting solution.

Monomers or prepolymers include, for example, water-dispersed urethane monomers, e.g., NeoRez™ products, R-9314, R-9630 and/or R-9679 commercially available from NeoResins (Wilmington, Mass.; formerly known as Zeneca Resins). Water-dispersed polyurethane monomers and/or prepolymers are preferably employed in Part A of the graft coating formulation in a concentration ranging from about 20 to 80 percent, by weight of Part A, and more preferably in a concentration ranging from about 30 to about 75 percent, by weight of Part A.

Aliphatic moisture-curable urethanes are also employed, e.g., the Spenlite™ M27-X-63 and/or the less viscous M22-X-40™ (Reichhold Chemical, Inc., Research Triangle Park, North Carolina), and D.R.R. G84 EK 40™ epoxy resin (Dow Chemical) and/or combinations thereof.

Other urethanes that are optionally employed include hydrophobically-modified ethylene oxide urethanes, such as those that are commercially available from the Rohm and Haas Company (Philadelphia, Pa.) as their Acrysol™ products including Acrysol™ 8M, RM-8W, RM-8 rheology modifiers, and related products.

Optionally other water-dispersed prepolymers include epoxy monomers, e.g., preferably including the epoxy monomers available as Epi-Rez™ products (Shell Chemical Co. Parsippany, N.J.).

Silicon-based monomers and/or prepolymers are optionally employed in Part A of the grafting solution. Desirable silicon-based monomers or prepolymers are preferably dispersible or otherwise miscible in the water based solvent of Part A. Suitable silicon polymers or prepolymers are preferably silane derivatives, including alkoxysilanes, dialkoxysilanes and trialkoxysilanes, such as the trimethoxysilanes, and epoxy silane esters. Most preferred is gamma-glycidoxypropyltrimethoxysilane, commercially available, e.g., as Silquest™ A187 (Osi Specialties, Inc., Danbury, Conn.). Silane derivatives are preferably added to Part A of the grafting solution in a concentration ranging from about 0.10 percent to about 0.50 percent by weight of Part A. More preferably, silane derivatives are added to Part A of the grafting solution in a concentration ranging from about 0.20 to a about 0.40 percent by weight of Part A.

In one preferred embodiment, vinyl and epoxy functional silanes, such as the vinyl triethoxy silane and vinyl trimethoxy silane monomers described supra, are added to the grafting solution in order to provide improved paintability and scratch resistance to the grafted surface. Such an improved surface allows the grafted articles to be readily painted or marked in any color or treated with any other useful adhesives or coatings after manufacture. With these improved surface properties, the grafted surface can be easily color-coded after manufacture, and/or marked with letters, numbers and other indicia. In another preferred embodiment, the grafted articles can be readily fixed or affixed to other articles by means of adhesive or glue-type systems.

In yet another preferred embodiment, additional components are optionally combined with the liquid composition. Such additional components include, e.g., one or more dyes or pigments that impart a heat-reflective property to the grafted coating to reduce solar heating of carbon steel, also known as black steel, as well as with any other art-known components commonly added to paints and coatings. Such reflective colorants include, simply by way of example, finely divided metal powders, in a proportion sufficient to give the finished grafted coating a metallic and reflective appearance.

In a further preferred embodiment, suitable inorganic or organic dyes or pigments that impart a marking color are mixed into the grafting solution or covalently linked by art-known methods to one or more of the components of the liquid composition. These include colorants that impart red, green, orange, yellow, blue, violet and variations of these. Suitable colorants for this purpose include, simply by way of example, Tint Ayd™ EP or UL (Red), green yellow, and/or combinations thereof, that are commercially available, for example, from Daniel Products, (Jersey City, N.J.).

Additional such pigments or colorants include, e.g., zirconium oxide, zircon, zinc oxide, iron oxide, antimony oxide, and particularly weather resistant coated types of TiO₂, such as WD 2002 Rutile Titan™ Elementis Specialties (Jersey City, N.J.) as product No. 6202

The pigments may also be blended with a suitable extender material which does not contribute significantly to hiding power. Suitable extenders include silicabaryte, calcium sulfate, magnesium silicate (talc), aluminum oxide, aluminum silicate, calcium silicate, calcium carbonate (mica), potassium aluminum silicate and other clays or clay-like materials. Where present, the pigments and extenders are normally present at a level of from about 0.1 to about 1.0 parts by weight per part by weight of the polymer components of the grafting composition, on a dry weight basis.

Further optional components of the liquid composition of the grafting solution and of the formed graft coating include, for example, anti-oxidants, U.V. absorbing compounds, and other polymer stabilizers well known to the art, in art-known proportions. The coating composition of the invention may also optionally include other ingredients in amounts which are commonly included in paint and lacquer formulations such, wetting agents, surfactants, bactericides, fungicides, mildew inhibitors, emulsifiers, suspending agents, flow control agents such as waxes or wax dispersions, level agents, thickening agents, pH control agents, slip agents such as silica or clay and the like.

Preferred water miscible wetting agents include CoatOSil® products from OSi Specialties (Greenwich, Conn.) and particularly CoatOSil® 1211. CoatOSil® and similar such wetting agents are preferably employed in a concentration ranging from about 0.05 to about 0.10 percent, by weight of Part A, and more preferably from about 0.06 to about 0.07 percent, by weight of Part A.

In a still further embodiment, any of the above-described monomers, including, simply by way of example, dispersed polyurethane in combination with, e.g., epoxy prepolymers Epi-Rez™ (Shell Chemical Co., Parsippany, N.J.), and NeoRez™ R-9679 (NeoResins, Wilmington, Mass.), are pre-linked with suitable colored dyes or pigments by art-known methods in order to provide a fully grafted and permanently colored surface to the treated metal substrates. Methods for linking dyes or pigments to these monomers are art-known. For example, the desired colorants and/or pigments are dissolved in monomers/prepolymer solution and then applied onto the desired substrate by any effective method (e.g., dipping or spraying), following by curing at, e.g., at about 150° F. for about 20 to about 30 minutes.

In yet a still further embodiment, one or more corrosion inhibitors are added to the formulation, e.g., are added to Part A. Any art-known corrosion inhibitor composition that is compatible and miscible with the components and solvents of the formulation is optionally employed. For example, art-known anticorrosion compounds and pigments include, one or more compounds such as SiO₂, Cr₂O₃, Cr(OH)₃, Al₂O₃, calcium hydroxide, calcium carbonate, calcium oxide, zinc phosphate, zinc hydrogen phosphate, potassium phosphate, potassium hydrogen phosphate, calcium phosphate, calcium hydrogen phosphate, calcium silicate, zirconium silicate, aluminum phosphate, aluminum hydrogen phosphate, titanium oxide, zirconium phosphate, zirconium hydrogen phosphate, sulfuric acid, sodium sulfate, sodium hydrogen sulfate, phosphoric acid, sodium phosphate and sodium hydrogen phosphate, ionomers of ethylene copolymers, and/or combinations of these.

A suitable formulation providing ionomers of ethylene copolymers is commercially available as various Acqual™ aqueous dispersions from Michalman, Inc. (Cincinnati, Ohio). Preferably, Acqual™ 220 is employed.

These are employed in art-known concentrations effective for long term anticorrosion protection, e.g., simply by way of example, in concentrations ranging from about 0.01% to about 25%, or more by weight, relative to the weight of the total of Part A of the grafting solution. More preferably, the corrosion inhibitor(s) is present in a concentration ranging from about 0.1 to about 15%, by weight of Part A.

As exemplified herein, zinc phosphate is another preferred anticorrosion agent. Zinc Phosphate is preferably employed in a concentration ranging from about 0.1 to about 1 percent of Part A, and more preferably from about 0.25 to about 0.50 weight percent of Part A. A suitable formulation providing zinc phosphate is Halox® from Halox Pigments (Hammond, Ind.).

The pH of the formulated liquid composition should preferably be in the range of from about 6-8, and appropriate amounts of a suitable acid, e.g. phosphoric or acetic acids or a base, e.g. sodium hydroxide, ammonia or ammonium hydroxide, may be included into the composition to adjust the pH as necessary.

Thus, the desired reagents, e.g., prepolymer(s) and/or monomers, catalyst, graft initiator system and other ingredients of the composition are mixed in a container with a compatible solvent or solvents to form Part A.

Formulation of Part B

Part B of the grafting solution is prepared as a separate solution to contain a polymerization promoter, such as a crosslinking compound. This strategy avoids premature gelation or hardening of the composition over periods of storage. Suitable crosslinking compounds include any art-known water soluble or miscible crosslinkers that will react with, and enhance crosslinking of the monomers or prepolymers employed for the grafting process. Such a polymerization promoter is particularly desired where the polymeric component contains functional groups which are capable of undergoing ionic condensation reactions, e.g., carboxy, hydroxy or epoxy.

Suitable polymerization promoters or crosslinking agents include melamine based amino resins such as hexamethoxymethylmelamine, benzoguanamine resins, urea formaldehyde resins, glycoluryl-based resins and like materials. Preferred crosslinking agents are those which are active at ambient temperatures, i.e., from about 20 to about 30° C. and include epoxy silanes such as gamma glycidoxypropyltrimethoxy silane, beta-(3,4-epoxycyclohexyl) ethyltrimethoxy silane and polyfunctional aziridines. In particular, the selected crosslinker is reactive with prepolymer or polymer carboxyl groups.

The crosslinker exemplified herein is a polyfunctional aziridine liquid crosslinker, such as, for example, 1-aziridinepropanoic acid, 2-methl-, 2 ethyl-2-(3-(2-methyl-1-aziridinyl)-1-oxypropoxy) methyl)-1,3-propandiyl ester marketed by NeoResins, Wilmington, Mass., under the tradename Crosslinker CX-100™. This is a trifunctional material with an equivalent weight of 156, that is used to crosslink monomers, prepolymers and/or polymers with reactive carboxyl functionality, in both water-based and organic solvent-based systems.

Optionally, other art-known components are provided in Part B, include, simply by way of example, hardeners, e.g., amine hardeners, stabilizers and the like.

### The Grafting Solution and Process

Parts A and B are mixed in a suitable proportion, stirred to a uniform solution, and the resulting grafting solution is applied to the substrate to be treated. The time necessary for the reaction to run to completion depends up the reaction temperature, the reagents employed and the desired properties of the graft coating after application and curing.

Preferably, the metal substrate to be coated is subjected to an optional pretreatment cleaning to remove any contaminating dust, grease and oil, prior to application of the grafting solution.

The mixed grafting solution is applied to the metal substrate, such as carbon steel, by any available art-known method, including, e.g., brushing, spraying, dipping, spin coating, vapor deposition, and the like. The viscosity of the grafting solution is adjusted as needed, so that, for example, it is sufficiently viscous for application by dipping or brushing, without significant dripping or running of the applied solution, or sufficiently thin when optionally sprayed onto the surface to be treated.

Generally, the solution is air dried onto the substrate, and then cured by the application of heat for a time period ranging, e.g., from about 30 seconds to about 4 hours, at a temperature ranging, e.g., from about 100 to about 150 degrees F. When heat curing is undesirable, the coated substrate can optionally be allowed to cure at ambient temperature, e.g., 25-30 degrees C., for a time ranging from about 30 seconds to about 6 or more days.

### Graft Coating Reaction

Without meaning to be bound by any theory or hypothesis as to any proposed mechanism underlying the grafting reaction of the inventive process, the grafting reaction is believed to take place by means of a chain polymerization. This type of polymerization reaction, also referred to in the art as a “backbiting” reaction, consists of initiation and propagation reactions. Essentially, a graft initiator is contacted with the surface to be treated, e.g., a surface of an article formed in whole, or in part, of a metal to be graft coated.

Although the mechanism of reaction between a metal surface and monomers or prepolymers of the invention is not fully established, it is believed that in the presence of moisture, a layer of oxides and hydroxyl groups becomes tenaciously bound to the metal substrate. The hydrogen of the hydroxyl group may be removed by the graft initiator to form a radical, which in turn reacts with the monomer or other provided reagent, starting graft polymerization.

### Reaction Pathway

The graft reaction can be better understood by considering the reaction scheme of FIG. 1, and following steps (1) through (6), wherein “M” is a metal substrate, “MO” is a metal oxide, “GI” is a graft initiator and Formula I, below,

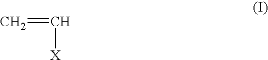

illustrates the active group of a monomer, wherein X is the residue of a unit of monomer. The selection of X governs the coating properties that are obtained. Optionally, a mixture of monomers are employed, and more than one property of the substrate can be modified or enhanced in a single processing step. Preferably, X is a water based urethane monomer. More preferably, the urethane monomer is an aliphatic urethane monomer.

Referring now to FIG. 1. Reaction 1 (a) illustrates the general reaction that takes place on the substrate wherein M is a surface metal moiety that is in equilibrium with atmospheric water, so that MOH is present on the surface of the metal substrate. The process begins when the inventive composition is contacted with the substrate. Contact is by any suitable method, including without limitation, brushing, spraying, rolling application and/or dipping. The composition includes a graft initiator or GI, e.g., a metal ion as discussed above. Reaction 1(b) occurs on the substrate surface, wherein MOH is activated to form MO^{•} and release H⁺.

In the presence of MO^{•} and optional polymerization catalyst, activated monomer, forms a covalent bond with the MO, as illustrated by reaction (2), and the terminal moiety of the monomer residue is activated and available for chain extension by adding another monomer, as illustrated by reaction (3). Both alternative reactions provide a coated substrate that possess all the desirable properties of the selected grafted polymer coating.

As the reaction proceeds and depleted GI accumulates, it can be regenerated by a peroxide species (“ROOH”), often referred to as a catalyst or polymerization initiator, as illustrated by reaction (4). This reaction also produces an activated residue of the peroxide (RO^{•}) which terminates the reaction as illustrated by reactions (5A) and (6). Reactions (5B) and (6) also illustrate chain termination on the activated surface moiety of MO, to provide multiple covalent anchors to the treated substrate.

The termination process may proceed differently when the coating composition formulation contains reactive prepolymers or polymers. The prepolymers may undergo activation by the graft initiator to produce reactive radicals (P) which then react with the MO^{•} radical on the metal surface to form a graft coating on the substrate, as illustrated by reaction (7).

### EXAMPLES

The following examples serve to provide further appreciation of the invention but are not meant in any way to restrict the effective scope of the invention.

### Example 1

### Grafting Formulation with Urethane Prepolymer

Table 1, below, lists the components in part by weight relative to Part A or Part B, respectively.

TABLE 1

| | Parts by | % Part A |
|---|---|---|
| | Weight | By Wt. |
| Part A | | |
| Deionized water (“DIW”) | 800.00 | 26.7 |
| Neorez R-9630¹ | 2150.00 | 71.8 |
| Silquest ™ A 187² | 2.00 | 0.0668 |
| ACqual-220³ | 12.00 | 0.40 |
| CoatOSil ® 1211² | 2.00 | .0668 |
| Ferrous ammonium sulfate (1% in DIW) | 15.00 | 0.50 |
| Urea peroxide (1% DIW) | 15.00 | 0.50 |
| PART B | | |
| Crosslinker CX-100 ™¹ | 45.00 | 1.50 |

¹NeoResins, Wilmington, Mass.
²OSi Specialties, Inc.
³Michalman, Inc. (Cincinnati, Ohio)

Preparation of Part A

Urethane prepolymer NeoReZ™ R-9314 was taken in a container and to it were added monomers, catalyst, graft initiator and other ingredients of the composition in the proportions described supra by Table 2. The contents were stirred to a uniform solution. The ingredients were taken in the concentration ratio as indicated in the composition by weight.

Preparation of the Formulation of A and B

The Part A solution was mixed with the Part B solution in a separate container, in a ratio of 100 parts of A to 0.65 parts of B, by weight. The mixed formulation was stirred until a uniform solution was obtained for the grafting process.

### Example 2

### Grafting Formulation with Urethane Prepolymer and Corrosion Inhibitor

Samples of carbon steel pipe were graft coated with the formulation of Table 2, below.

TABLE 2

| | Parts by | % Part A |
|---|---|---|
| | Weight | By Wt. |
| Part A | | |
| Neorez R-9630¹ | 715.00 | 77.3 |
| DIW | 100.00 | 10.8 |
| Dowanol EB-solvent² | 50.00 | 5.4 |
| ACqual ™ 220¹ | 45.00 | 4.9 |
| Shieldex ™ (silica) | 4.00 | 0.43 |
| Zinc phosphate (corrosion inhibitor) | 4.00 | 0.43 |
| Disperse Ayd ™ 28³ (color tint) | 0.50 | 0.54 |
| Silquest ™ 187 | 2.00 | 0.22 |
| Ferrous ammonium sulfate (1% in DIW) | 2.00 | 0.22 |
| Urea peroxide (1% in DIW) | 2.00 | 0.22 |
| PART B | | |
| Crosslinker CX-100 ™¹ | 7.50 | 0.81 |

¹NeoResins, Wilmington, MA
²Ethylene glycol mono-n-butyl ether
³Daniel Products, (Jersey City, New Jersey)

Preparation of PART A

Aliphatic moisture curing urethane prepolymer Neorez R-9314 was taken in a container, and to it were added monomers, catalyst, graft initiator system and the other ingredients of the composition were added together and stirred as described by Example 1.

### Example 3

### Grafting Formulation with Urethane Prepolymer

Table 3, below, lists the components in part by weight relative to Part A or Part B, respectively

TABLE 4

| | Parts by | % Part A |
|---|---|---|
| | Weight | By Wt. |
| Part A | | |
| Polyurethane prepolymer | 100.0 | 59.0 |
| NeoRez ™ R-9314 | | |
| Dowanol EB ™ Solvent | 9.30 | 5.49 |
| Deionized water (“DIW”) | 37.21 | 22.0 |
| Silquest ™ A-187 | 0.56 | 0.33 |
| ACqual ™ 220 | 20.83 | 12.3 |
| CoatOSil ® 1211 | 0.093 | .006 |
| Ferrous ammonium sulfate (1% in DIW) | 0.69 | 0.40 |
| Urea peroxide (1% in DIW) | 0.69 | 0.40 |
| PART B | | |
| Crosslinker CX-100 ™ | 2.08 | 1.22 |

Ratio: Mix Part A:Part B = 100:1.3
Cure 30 minutes at room temperature and 25 minutes at 260° F.

### Example 4

### Grafting Formulation with Urethane Prepolymer

Table 4, below, lists the components in part by weight relative to Part A or Part B, rspectively

TABLE 4

| | |
|---|---|
| Parts by | % Part A |
| Weight | By Wt. |

Part A

| | | |
|---|---|---|
| Polyurethane prepolymer | 100.0 | 33.8 |
| NeoRez ™ R-9314 | | |
| Dowanol EB | 13.33 | 4.5 |
| Deionized water (“DIW”) | 53.33 | 18.0 |
| Silquest A-187 ™ | 0.8 | 0.27 |
| ACqual 220 ™ | 10.67 | 3.6 |
| Shieldex ™ (silica) | 1.07 | 0.36 |
| Zinc phosphate | 1.07 | 0.36 |
| WD 2002 (TiO₂ pigment) | 106.67 | 36.1 |
| Acrysol 8M ™ | 7.47 | 0.25 |
| Ferrous ammonium sulfate (1% in DIW) | 0.53 | 0.18 |
| Urea peroxide (1% in DIW) | 0.53 | 0.18 |
| PART B | | |
| Crosslinker CX-100 ™ | 2.80 | 0.95 |

Ratio: Mix Part A:Part B = 100:1.3
Cure 30 minutes at room temperature and 25 minutes at 260° F.

### Example 5

### Corrosion Testing

Testing Method

In brief, samples of the carbon steel pipe, graft coated with the above formulations, together with untreated controls, are subjected to a damp outdoor-type environment.

Results

After 30-60 days, the graft coated pipe remains free of corrosion, but untreated pipe is visibly rusted on exposed surfaces. These results confirm that a substantial degree of rust or corrosion protection is provided by the graft treatment as exemplified above.

What is claimed is:

1. A graft coated substrate and a graft coating covalently bonded thereto, wherein said substrate comprises a metal, and said graft coating comprises a polymer or copolymer and an effective amount of at least one corrosion inhibitor.

2. The graft coated substrate of claim 1, wherein the corrosion inhibitor comprises a an effective concentration of zinc phosphate.

3. The graft coated substrate of claim 1, wherein the graft coating comprises a polymer selected from the group consisting of a urethane, an epoxy, a polysilicon, and combinations thereof.

4. The graft coated substrate of claim 1 wherein the graft coating further comprises materials selected from the group consisting of a pigment or colorant, an antioxidant, an ultraviolet blocker, and combinations thereof.

5. The graft coated substrate of claim 1, wherein the substrate comprises a metal or metal alloy selected from the group consisting of iron, steel, brass, copper, aluminum, silver, and combinations thereof.

6. The graft coated substrate of claim 1 that is an article of manufacture selected from the group consisting of a pipe or tube, a curved or planar sheet, a beam, a rod or shaft, a container for solids or fluids, and combinations thereof.

7. The graft coated substrate of claim 6 wherein the pipe is selected from the group consisting of straight pipe, bent pipe, a straight pipe joint, an elbow joint, an end-cap, a heat-shrinkable joint, and combinations thereof.

8. A liquid composition for graft coating a substrate comprising an effective amount of a water-based or water-dispersed monomer or prepolymer, a graft initiator, a catalyst, a corrosion inhibitor, and a polymerization promoter.

9. The liquid composition of claim 8, wherein the corrosion inhibitor comprises an effective concentration of zinc phosphate.

10. The liquid composition of claim 8, wherein the monomer or prepolymer is a urethane ranging in concentration from about 20 to 80 percent, by weight.

11. A liquid composition for graft coating a substrate comprising a binary system formulated into separate Parts A and B, wherein Part A comprises a water-based or water-dispersed monomer or prepolymer, a graft initiator, a catalyst, an effective concentration of corrosion inhibitor, and a water-compatible silicon-based monomer or prepolymer and Part B comprises an effective amount of a compatible crosslinker, and Part A and Part B are separately prepared and stored.

12. The liquid composition of claim 11 wherein the water-based or water-dispersed monomer or prepolymer comprises from about 20% to about 80% by weight of Part A. urethane

13. The liquid composition of claim 11 wherein the water-based or water-dispersed monomer or prepolymer comprises epoxy monomers.

14. The liquid composition of claim 11 wherein the water-based or water-dispersed monomer or prepolymer comprises urethane monomers.

15. The liquid composition of claim 11 wherein the graft initiator comprises a metal ion ranging from about 0.01% to about 1.0% by weight of Part A.

16. The liquid composition of claim 11 wherein the graft initiator is a metal ion selected from the group consisting of ions of iron, silver, cobalt, copper, cerium, and combinations thereof.

17. The liquid composition of claim 11 wherein the catalyst is a peroxide that comprises from about 0.01% to about 1.0% of Part A.

18. The liquid composition of claim 11 that further comprises water miscible wetting agents from about 0.05% to about 0.10% by weight of Part A.

19. The liquid composition of claim 11 wherein Part B comprises an effective amount of a compatible crosslinking agent.

20. The liquid composition of claim 11 wherein the crosslinking agent is a polyfunctional aziridine liquid crosslinker.

21. The liquid composition of claim 11 wherein Part A comprises a formulation selected from the group consisting of the formulation shown by Table 1, Table 2, Table 3 and Table 4.

22. A method of protecting a metal substrate from rust or corrosion comprising contacting a metal substrate with the graft coating solution of claim 8, under conditions effective to promote grafting of the monomer or prepolymer to the metal substrate, and curing the applied graft coating solution.

23. A method of protecting a metal substrate from rust or corrosion comprising combining Parts A and B of claim 11 to form a graft coating solution, contacting a metal substrate with said graft coating solution under conditions effective to promote grafting of the monomer or prepolymer to the metal substrate, and curing the applied graft coating solution.

24. The method of claim 22 wherein the metal substrate is carbon steel. the composition of claim 11.
